(19) United States
(12) Patent Application Publication
(10) Pub. No.: US 2014/0323181 A1
(43) Pub. Date: Oct. 30, 2014

(54) Accessory for data acquisition and data transfer to an external device

(71) Applicants: Mahesh Subramaniam, Bangalore (IN); Jamuna Rani Balu, Chennai (IN)

(72) Inventors: Mahesh Subramaniam, Bangalore (IN); Jamuna Rani Balu, Chennai (IN)

(73) Assignee: HCL Technologies Limited, Chennai (IN)

(21) Appl. No.: 13/874,459

(22) Filed: Apr. 30, 2013

(51) Int. Cl. H04W 92/08

(52) U.S. Cl. CPC H04W 92/08
USPC 455/557

(57) ABSTRACT

A system and method to acquire data from a sensor and transfer the data to an external device is disclosed. The sensor retrieves data that corresponds to vibration or pressure and send the millivolt (mV) signal to an accessory. The accessory acquires the data will be much more cost effective compared to dedicated instruments to acquire data and analyze data in itself. The external device collects data and can email the data or sent to cloud due to ready interface from the external device. More advanced calculations can be performed on cloud and results sent back to the external device for detail analysis. The embodiment provides such back and forth analysis using the accessory.

The present application claims priority from Indian Application Number 4675/CHE/2012, filed on 7 Nov. 2012, the disclosure of which is hereby incorporated by reference herein.

### TECHNICAL FIELD

The embodiments herein relate to data acquisition and data transfer and more particularly relates to an accessory for data acquisition and data transfer.

### BACKGROUND

Usage of sensors to measure critical parameters helps us achieve wide measurements in both electrical and mechanical measurements. A sensor or a detector is a converter to measure physical quantity and converts it into a signal which can be read by an observer or by an electronic instrument. Sensors offer greater flexibility to the user to measure critical parameters which would otherwise be difficult to measure.

In modern world, sensor has high significance to measure vibration and pressure exerted by the devices. For example, vibration exerted by the motor or a pump needs to be measured, in order to attain high efficiency. Sensor acquires data and send to any devices connected to the sensor.

Vibration sensors measure vibrations of the equipment and transfer the millivolt (mV) signal to any dedicated devices to perform analysis. Existing portable vibration analyzers are dedicated instruments to analyze and interpret the data to the user.

In light of above discussion, existing devices do not provide an interface to phone or offer the vibration monitoring on phones. Thus, there is a need for an accessory to obtain parameters from a sensor and transfer the parameters to any device for analysis is anticipated.

### SUMMARY

Accordingly the embodiment provides a system for data acquisition and transferring the data, the system comprises a sensor, an accessory, an external device, wherein the system is configured to acquire the data from the sensor, transfer the data to the external device and analyze the transferred data by the external device.

Accordingly the embodiment provides an accessory to acquire data and transfer the data to an external device, wherein the accessory comprises a microcontroller, an Analog-to-Digital Converter (ADC) module, an external flash memory, a battery module, a Universal Asynchronous Receiver/Transmitter (UART), an antenna, wherein the accessory is configured to acquire analog data from the sensor, convert the analog data to digital data using the ADC module, read the digital data using the microcontroller, store the digital data in the external flash memory using the microcontroller and transfer the digital data to the external device.

Accordingly the embodiment provides a method to acquire data and transfer the data to an external device, wherein the method comprises acquiring the data from a sensor, transferring the data to the external device and analyzing the transferred data by the external device.

### BRIEF DESCRIPTION OF THE FIGURES

The embodiments herein will be better understood from the following detailed description with reference to the drawings, in which:

FIG. 1 illustrates an overview of the data acquisition and transfer using wired connection, according to the embodiments disclosed herein;

FIG. 2 illustrates the hardware block diagram of the accessory in wired connection, according to the embodiments disclosed herein;

FIG. 3 illustrates an overview of the data acquisition and transfer using wireless connection, according to the embodiments disclosed herein; and

FIG. 4 illustrates hardware block diagram of the accessory in wireless connection, according to embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a system and method to data acquisition and transfer. The system comprises a sensor, an accessory and an external device. The accessory acquires data from the sensor and transfers the data to the external device for analysis. The accessory and the device are connected through a wired or wireless communication. The sensor and the accessory are communicated in a wired connection. The accessory comprises a storage module to store the data received from the sensor and transfer the data to the external device asynchronously. The data also can be resent if there is any loss of data during communication to the external device. The accessory is capable of powering the sensor connected to the accessory.

Throughout the description the term parameters and data is used interchangeably.

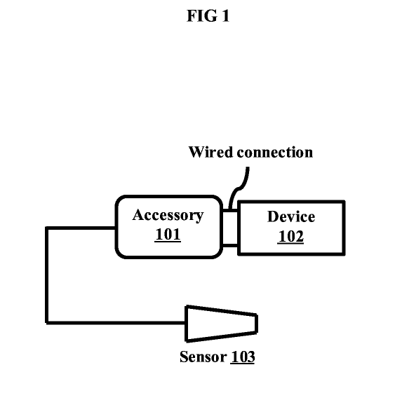

FIG. 1 illustrates an overview of the data acquisition and transfer using wired connection, according to the embodiments disclosed herein. The figure depicts an accessory 101, an external device 102 and a sensor 103. In an embodiment, the sensor 103 can be a vibration sensor, pressure sensor that is capable of sending millivolt (mV) signal to the accessory 101. In an embodiment, there can be plurality of sensors retrieving the parameters and transfer the parameters to the accessory.

In an embodiment, the external device 102 can be a mobile telephone, a cellular phone, a personal communications system (PCS) terminal that may combine a cellular radiotelephone with data processing, facsimile, and/or data communications capabilities, an electronic notepad, a laptop, a personal computer, a tablet, a personal digital assistant (PDA), smart phone, a gaming device or console, a peripheral (e.g., wireless headphone), a digital camera, a media player and the like. The external device 102 comprises an operating system such as Apple's iOS, Microsoft Windows, Google's Android, and Mozilla's Firefox OS, Nokia's Symbian, Research In Motion's (RIM) BlackBerry and so on.

The accessory 101 (also called Dongle) reads data from the sensor 103 (also called Accelerometer) and sends it to the external device 102 by means of a wired connection.

In an embodiment, the wired connection includes but not limited to pin connector, cable connector, Universal Serial Bus (USB) and so on.

For example, accessory 101 reads data from the vibration sensor 103 and sends it to an iPhone using UART as transport layer and using iAP (iPhone Accessory protocol) through an “Apple dock connector”.

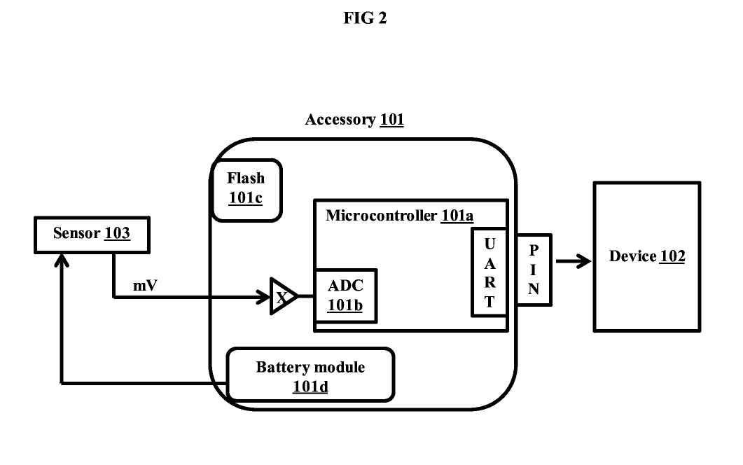

FIG. 2 illustrates the hardware block diagram of the accessory in wired connection, according to the embodiments disclosed herein. The figure depicts the major components of the accessory 101. The sensor 103 measures the parameters of the equipment and sends the parameters in millivolts (mV) to the accessory 101. The sensor 103 or accelerometer is a standard accelerometer and not part of embodiment. Users can choose accelerometer based on equipment that needs to measure the parameters.

In an embodiment, the parameter can be vibration on rotating equipments ranging from a turbine to a small pump, pressure exerted in the equipment, physiological data.

The accessory 101 comprises a microcontroller 101a, an Analog-to-Digital converter (ADC) module 101b, an external flash memory 101c and a battery module 101d. In an embodiment, the ADC 101b can be a 12 bit ADC convertor which is a part of micro controller 101a. The ADC 101b converts the mV signal to digital signal that will be accessed by microcontroller 101a.

In an embodiment, the microcontroller (μC) 101a can be a 16 bit μC (MSP Controller from Texas Instruments) which reads the data from ADC 101b and buffer the incoming data, and store into external flash memory 101c. The execution rate of μC can be varied from the external device 102 (iPhone) and send to serial interface. The minimum scan period possible will be 0.25 milliseconds or 250 Microseconds. The μC shall also execute the tasks based a state machine.

The external flash memory 101c archives data and store initial configuration values. In an embodiment, the size of the flash memory 101c can be 4 GB, 8 GB. The data stored in flash will be sent to the external device 102. For example, the data stored in the flash will be sent to iPhone.

In an embodiment, the external flash memory 101c outside the processor, stores incoming data from the sensor 103. This makes it possible to send the data to the external device 102 asynchronously and data can be resent should there be any loss of data during communication to the external device 102.

For example, the external flash memory stores incoming data from the vibration sensor. This makes it possible to send the data to iPhone asynchronously and data can be resent should there be any loss of data during communication to iPhone.

The battery module 101d in the accessory 101 powers the sensor 103 connected to the accessory 101. In an embodiment, sensors operate at 18-30V DC and external device 102 cannot power the sensors 103 and accessory 101. In an embodiment, the accessory battery can be recharged using the device charger. For example, the accessory battery can be recharged using the iPhone charger.

The UART interface in the accessory 101 sends the data from flash to the external device 102 using UART as transport layer and a protocol. For example, the data is sent to an iPhone using UART as transport layer and an iPhone Accessory Protocol (IAP) protocol.

The accessory 101 connects with the external device 102 by means of a pin connector. For example, the accessory 101 comprise a male connector to mate with iPhone.

The external device 102 read the data from the accessory 101 and store in its hard disk and software. Then the external device 102 analyzes data and displays the results in multiple ways to the user. In an embodiment, the analysis results can be displayed as graph, charts and so on. In an embodiment, the external device 102 can send the data to cloud database to analyze data and retrieve results. For example, the iPhone connected with the accessory 101 analyze data and display the trends of vibration data.

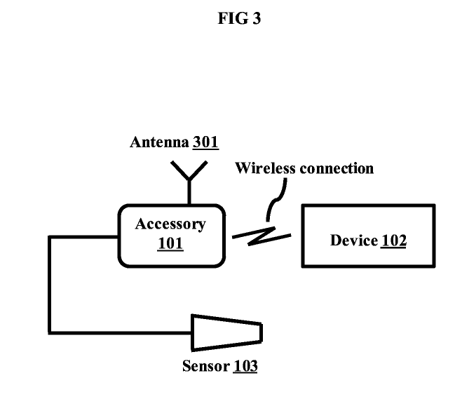

FIG. 3 illustrates an overview of the data acquisition and transfer using wireless connection, according to the embodiments disclosed herein. The figure depicts the accessory 101 with an antenna 301. The accessory 101 is connected with the external device 102 using a wireless connection. In an embodiment, the wireless connection can be Zigbee, Bluetooth, Wireless HART, 6LowPAN (IPv6), Infrared, and Near-Field Communication (NFC) and so on.

For example, the sensor 103 and the accessory 101 are separated from the external device 102 and data from accessory 101 is communicated using Bluetooth to the external device 102. The sensor 103 and accessory 101 are connected to each by wires.

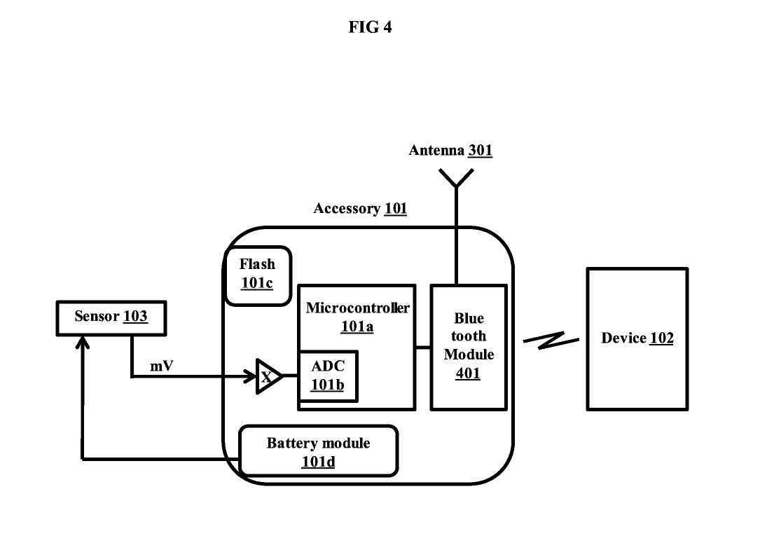

FIG. 4 illustrates hardware block diagram of the accessory in wireless connection, according to embodiments disclosed herein. The figure depicts the sensor 103, accessory 101 and the external device 102. The accessory 101 comprises the microcontroller 101a, ADC 101b, external flash memory 101c, battery module 101d, antenna 301 and a Bluetooth module 401.

As depicted in the figure, the Bluetooth module 401 with an antenna 301 replaces the Pin connector. The Bluetooth module 401 retrieves the data from main processor and converts to Bluetooth format and sends the data to the external device 102 using Bluetooth communication protocol. Similarly, the Bluetooth module 401 also receives commands sent from the external device 102 and updates the micro controller 101a. UART is not required to transfer the data to the external device 102.

For example, the Bluetooth module retrieves the data from main processor and converts to Bluetooth format and sends the data to a smart phone. Similarly it also receives commands sent from the smart phone and updates the micro controller.

Certain phone manufacturers require the use of an authentication chip purchased from them to transmit/receive data on Bluetooth. And few manufacturers do not need any authentication chip. In order to make the accessory generic to be used with any smart phone, a hardware toggle selection is implemented to choose the type of phone and the toggle selection is provided on top of the accessory. Accordingly the relevant hardware circuit is activated.

In an embodiment, the external device 102 comprises a software complementing the accessory functionality is loaded onto the external device 102. Some of domain specific software that needs to be created based on type of accessory is given below:

Vibration Monitoring—Fast Fourier Transform, Wavelets, Bode plots.

Give commands to calibrate sensors note the actual calibration will be done by μC

Other than the above, the device should also have general applications such as:

Trend display including replay of historical data stored in flash memory of the accessory.

Event Log—Display the diagnostics messages, alarms

Role authorization—Based on user's role, features on the application shall be enabled

Reports generation—Ability to generate customized reports on the fly

Ability to send data to cloud database or any other data repository by using web services/GPRS.

In an example, the accessory is used in medical applications to sense human blood pressure or monitor the pulse and send the data to an external device for analysis.

In another example, the accessory is used in consumer electronics along with iPhone to control remotely music speakers and players, television and other home electronic appliances.

In yet another example, the accessory is used in Automobiles as Onboard Diagnostic port ODB-II in cars. The accessory can connect to port in wired/wireless mode and collect engine data and send the data to the iPhone for analysis.

The embodiments disclosed herein can be implemented through at least one software program running on at least one hardware device and performing network management functions to control the elements. The elements shown in FIGS. 1 through 4 include blocks which can be at least one of a hardware device, or a combination of hardware device and software module.

The embodiment disclosed herein specifies a system and method to acquire data from a sensor and transfer the data to an external device in either wired or wireless communication. Therefore, it is understood that the scope of the protection is extended to such system and in addition to a computer readable means having a message therein, such computer readable storage means contain program code means for implementation of the system.

The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A system for data acquisition and transferring said data, said system comprises a sensor, an accessory, an external device, wherein said system is configured to:
acquire said data from said sensor;
transfer said data to said external device; and
analyze said transferred data by said external device.

2. The system as in claim 1, wherein said system is configured to acquire said data using said accessory and said accessory transfers said data to said external device.

3. The system as in claim 2, wherein system is configured to transfer said data using at least one of: wired, wireless communication to said external device.

4. The system as in claim 1, wherein said external device is configured to analyze said data and interpret said data.

5. The system as in claim 1, wherein said external device is configured to send said transferred data to a cloud database to analyze said data and said cloud database sends said analyzed data to said external device.

6. An accessory to acquire data and transfer said data to an external device, wherein said accessory comprises:
a microcontroller;
an Analog-to-Digital Converter (ADC) module;
an external flash memory;
a battery module;
a Universal Asynchronous Receiver/Transmitter (UART)
an antenna;
wherein said accessory is configured to:
acquire analog data from said sensor;
convert said analog data to digital data using said ADC module;
read said digital data using said microcontroller;
store said digital data in said external flash memory using said microcontroller; and
transfer said digital data to said external device.

7. The accessory as in claim 6, wherein said accessory is configured to transfer said digital data to an external device using at least one of: wired, wireless communication.

8. The accessory as in claim 7, wherein said wireless communication comprises at least one of: Zigbee, Bluetooth, Wireless HART, IPv6, Infrared, and Near-Field communication (NFC).

9. The accessory as in claim 6, wherein said accessory is configured to power said sensor using said battery module.

10. The accessory as in claim 6, wherein said accessory is configured to store said data in said external flash memory and transfer said data to said external device asynchronously.

11. A method to acquire data and transfer said data to an external device, wherein said method comprises:
acquiring said data from a sensor;
transferring said data to said external device; and
analyzing said transferred data by said external device.
